(19) United States
(12) Patent Application Publication
(10) Pub. No.: US 2004/0125152 A1
(43) Pub. Date: Jul. 1, 2004

(54) User customizable, locale dependent, variant character entry method and apparatus

(76) Inventors: Daniel Ray Sommers, Roswell, GA (US); Timothy Alan Monahan-Mitchell, Cumming, GA (US); Mark Patrick Simpson, West Palm Beach, FL (US); Jed Lawton Coxon, Alpharetta, GA (US); James Phillip Mason, Alpharetta, GA (US)

Correspondence Address: VEDDER PRICE KAUFMAN & KAMMHOLZ, 222 N. LASALLE STREET, CHICAGO, IL, 60601, US

(21) Appl. No.: 10/335,271

(22) Filed: Dec. 31, 2002

(51) Int. Cl. G09G 5/00

(52) U.S. Cl. 345/856

(57) ABSTRACT

A method and apparatus (100) for entry of variant characters provide a user interface (102) to allow a user to select a variant character list (302) for a specific language and optionally customize the list to the user's preferences. Processing circuitry (104) allows the user to add and delete variants from a previously stored default table and/or change the order in which the variants are displayed for each character. The user enters a variant character entry mode by depressing a character key for a predetermined period of time, followed by repeatedly depressing the same key to scroll through possible variants. Variants for the selected key are then displayed at a highlighted cursor position on a display (106). The user selects the desired variant by pressing a key while the desired variant is being highlighted.

### FIELD OF THE INVENTION

The invention relates generally to alphabetic entry on an electronic device, and in particular, to a method and apparatus for customizing entry of variant characters using an electronic device's user interface.

### BACKGROUND OF THE INVENTION

The number of keys on a keyboard, such as touchscreen keyboards or keyboards with depressible keys, is limited by the size and shape of the keyboard. Such limitation is particularly true for handheld devices, which are restricted to small keyboards due to their size. As a result, keyboard buttons are often given multiple meanings through multi-key mechanisms, such as “shift” and “alt”, in an attempt to expand the keyboard's functionality within the particular size constraints. Furthermore, symbols and non-standard characters are made available in look-up tables, but the retrieval of the desired symbol or character may necessitate time-consuming navigation through multiple screens and key presses.

Unfortunately, the foregoing keyboard expansion mechanisms fall short in a multi-language environment for a variety of reasons. For example, a large number of diacritical variants may exist for the same base character. Furthermore, the user's native language may only contain a small number of non-ASCII characters, and burdening them with all variants for all languages may lead to confusion and increase the required number of key strokes to find the small number of variants they might actually use. Country-specific keyboards can offer direct entry of more of the native characters, but these keyboards do not help a user composing text in another language. Finally, users need intuitive ergonomic interfaces without the constant need for manuals. Multi-key sequences to add diacritical marks to Latin letters, for example, can be confusing, and typically do not handle digraphs or other symbols, such as Greek letters. Thus, there is a need for interfaces that are tailored to the user's locale and that can be further tailored according to the specific needs of the user.

### BRIEF DESCRIPTION OF THE DRAWINGS

The invention will be more readily understood with reference to the following drawings wherein like reference numerals represent like elements and wherein:

FIG. 1 is a block diagram of an electronic device in accordance with the present invention;

FIG. 2 is flow chart illustrating customization of a default variant character list by a user according to one embodiment of the present invention;

FIG. 3 illustrates a partial default variant character list for the Swedish language according to one embodiment of the present invention;

FIG. 4 illustrates a menu for selecting a language according to a preferred embodiment of the present invention;

FIG. 5 illustrates a control screen for customizing a variant character list according to a preferred embodiment of the invention;

FIG. 6 illustrates a partial customized variant character list for the Swedish language according to one embodiment of the present invention;

FIG. 7 illustrates a control screen for allowing access to all possible character variants according to one embodiment of the invention;

FIGS. 8-9 are flow charts illustrating a variant character entry method according to one embodiment of the present invention;

FIG. 10 is a flow chart illustrating a variant character entry method according to another embodiment of the present invention;

FIGS. 11-12 are examples of user interface windows illustrating entry of a Spanish word according to one embodiment of the present invention; and

FIGS. 13-16 are examples of user interface windows illustrating entry of a French word according to another embodiment of the present invention.

### DETAILED DESCRIPTION OF A PREFERRED EMBODIMENT

Briefly, an electronic device includes a user interface through which a device user selects a variant character list for a specific language and optionally customizes the list to the user's preferences. The user can add and delete variants from a previously stored default table and/or change the order in which the variants are displayed for each character. The user enters a variant entry mode by simply holding down a character key for a predetermined period of time. Variants for the character associated with the selected key are then displayed at a highlighted cursor position on a display. The user selects the desired variant by pressing a new key while the desired variant is being highlighted.

According to a preferred embodiment of the present invention, when a character key is depressed for a predetermined period of time (e.g., one second or other suitable time), the electronic device enters a variant character selection mode. The character associated with the depressed key is highlighted at a cursor position on a display. A stored variant character list for the character is cycled through at the highlighted cursor position on the display when a separate, navigation key is repeatedly pressed. The highlighting ends when any key other than the navigation key is pressed, and the electronic device displays the variant character that was highlighted when the highlighting ended to designate the entered character for the previously highlighted cursor position.

According to another embodiment of the present invention, when a character key is depressed for a predetermined period of time, the electronic device enters a variant character selection mode. The character associated with the depressed key is highlighted at a cursor position on a display. A stored variant character list for the character is cycled through at the highlighted cursor position on the display while the character key continues to be depressed. The highlighting ends when the character key is released, and the electronic device displays the variant character that was highlighted when the character key was released to designate the entered character for the previously highlighted cursor position.

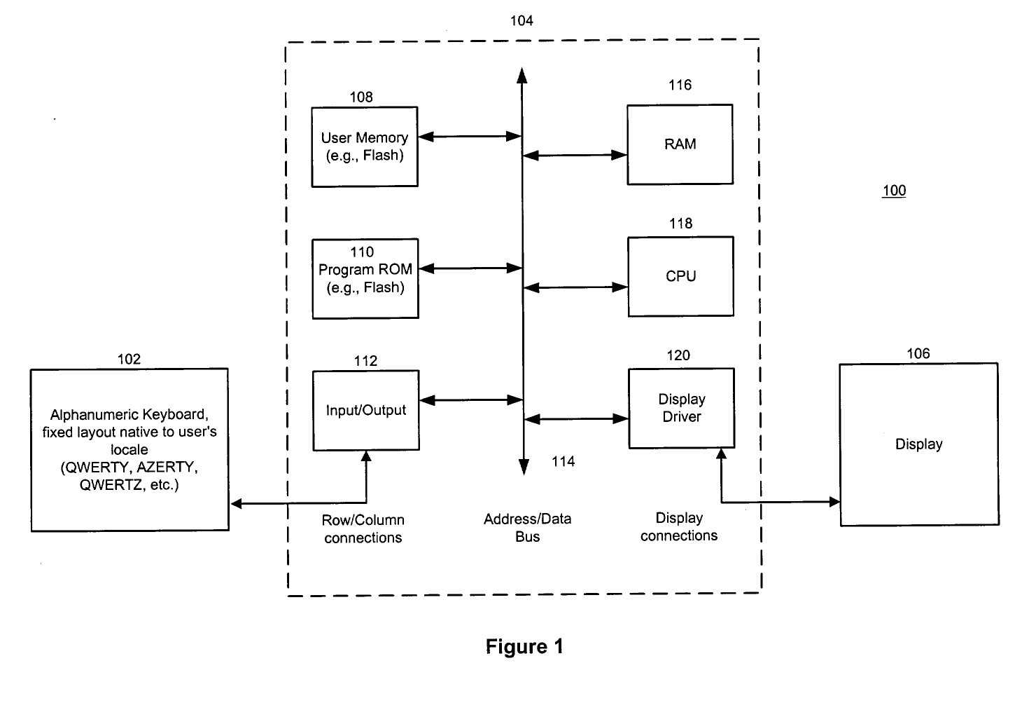

FIG. 1 illustrates an electronic device 100 in accordance with a preferred embodiment of the present invention. The electronic device 100 may be a desktop or personal computer, a laptop computer, a wireless handheld device, a personal digital assistant (PDA) or any other suitable device. The electronic device 100 preferably includes an alphanumeric keyboard 102, processing circuitry 104 and a display 106. It will be understood by one skilled in the art that the alphanumeric keyboard 102 can be a physical keyboard having any one of a variety of known key configurations, such as QWERTY, AZERTY, or QWERTZ; a pop-up interactive keyboard that is displayed on part of the display 106; or any other user interface that permits the selection of letters. As such as used herein “depressed” or “holding down” includes any key activation technique.

In the preferred embodiment, the processing circuitry 104 includes a user memory 108, such as a flash memory, a program read only memory (ROM) 110, such as a flash memory, an input/output interface 112 for controlling the interaction between the keyboard 102 and the processing circuitry 104, a random access memory (RAM) 116, a central processing unit (CPU) 118 for controlling the operation of the processing circuitry 104, and a display driver 120, controlled by the CPU 118, for controlling the display 106. Each of the components of the processing circuitry 104 is operatively coupled (logically or physically) to an address/data bus 114. The CPU 118 executes programmable instructions stored in the ROM 110, or other memory element, to effect operations as described herein. Factory loaded default tables of variant character lists for each available language are stored in the user memory 108. It will be recognized that alternative embodiments of the processing circuitry 104 may include more or fewer components and/or operations than does the processing circuitry 104 described above with respect to FIG. 1.

As used herein, processing circuitry 104 includes one or more processing, devices such as microprocessors, digital signal processors (DSPs), microcontrollers, discrete logic circuits, state machines or any other suitable structure, including, but limited to, any suitable combination of hardware, software or firmware. Hence it will be recognized that although the processing circuitry 104, in the form of a CPU 118 and associated memory 110 containing executable instructions is used to carry out the operations described herein using graphic user interfaces, any other suitable structure may also be used.

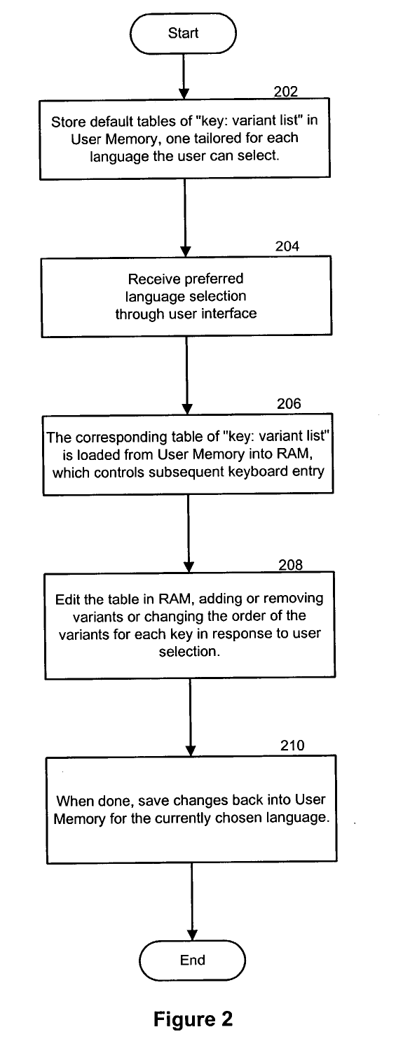

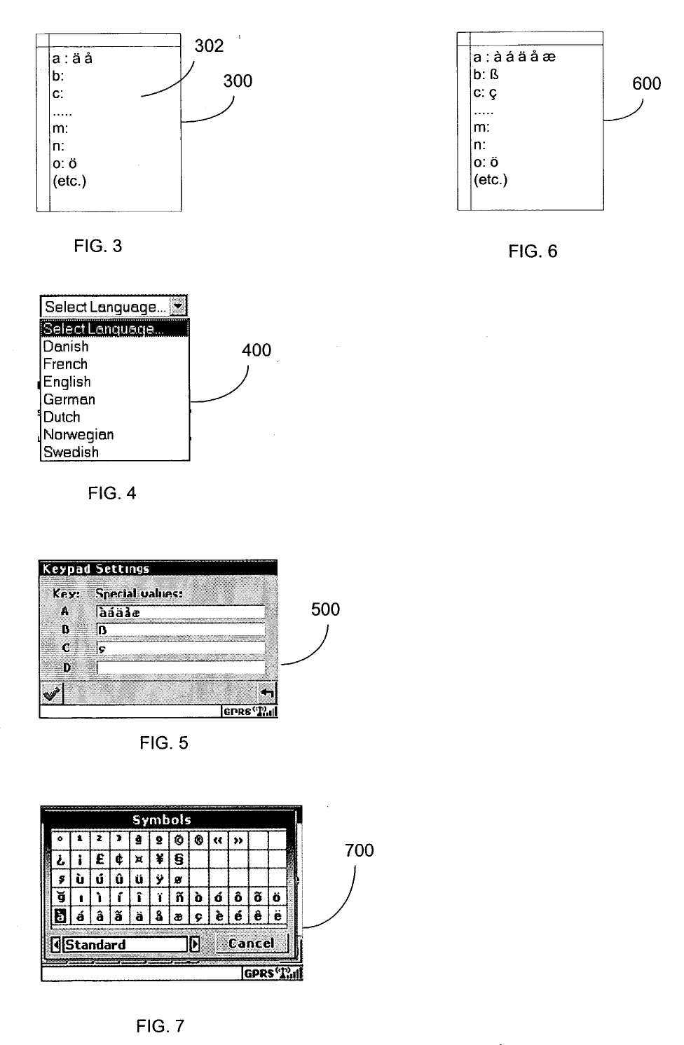

The default tables of variant character lists stored in the user memory 108 can be customized by the user as illustrated in FIG. 2. As mentioned above, the default tables are stored in the user memory 108 preferably during fabrication of the electronic device 100 or otherwise prior to delivery of the electronic device 100 to the user, as provided in step 202. FIG. 3 illustrates an example of a default table 300 for the Swedish language containing a list of variant characters 302. Through the use of menus displayed on the device 100 as provided by one or more software modules stored in the program ROM 110 and executed by the CPU 118 or another suitable processing device, a user can select his/her preferred text entry language, as provided in step 204. FIG. 4 illustrates an example of a selection menu 400 for the selection of a language, wherein the user can select from Danish, French, English, German, Dutch, Norwegian, and Swedish, but the present invention is not limited thereto as default tables for any number of different languages can be stored in the user memory 108 and displayed through a menu, such as the menu 400 illustrated in FIG. 4. The default table of the variant character list corresponding to the selected language is loaded from the user memory 108 into the RAM 116, which controls subsequent keyboard entry, as provided in step 206. Through the use of menus in the device 100, the user can edit the selected default table stored in the RAM 116, adding and/or removing variants from the list or changing the order in which the variants appear for each character in the list, as provided in step 208. Hence, the CPU 118 receives user selections in response to a presented user interface in the form of windows and menus.

User customization, through graphic user interface menus, allows for greater control over the settings of the selected language. For example, a person selecting the default table for the Swedish language may need more variants for the character “a” than the two variants “ä” and “å” which are listed in the default list illustrated in FIG. 3. The user can navigate through a series of control panel screens to arrive at a screen allowing a specific key or keys to be customized. For example, FIG. 5 illustrates a control screen 500 for customizing the variant list for characters “a”, “b”, “c”, and “d”. In this illustrative example, the user has added the variants “a”, “á”, and “æ” to the variant list for the “a” key, the variant “β” to the variant list for the “b” key, and added the variant “ç” to the variant list for the “c” key. The updated Swedish language table 600 is illustrated in FIG. 6. When the user is finished customizing the table, the device 100 saves the changes back in the user memory 108 for future use in step 210.

It will be understood by one skilled in the art that there are a variety of ways to allow the user to modify the default tables and the invention is not limited to any particular manner. For example, all possible variants for each letter may be displayed and the user can simply delete the variants which the user does not want in the customized table. Likewise, a list of all variants for each letter may be displayed and the user can select which variants are to be added to the default table. Further, additional symbols such as the Greek symbol “α” can also be added to the customized table. Furthermore, all possible alphabetic and symbolic characters may be displayed for selection as illustrated in FIG. 7. Also, the tables may be stored in one or more suitable databases.

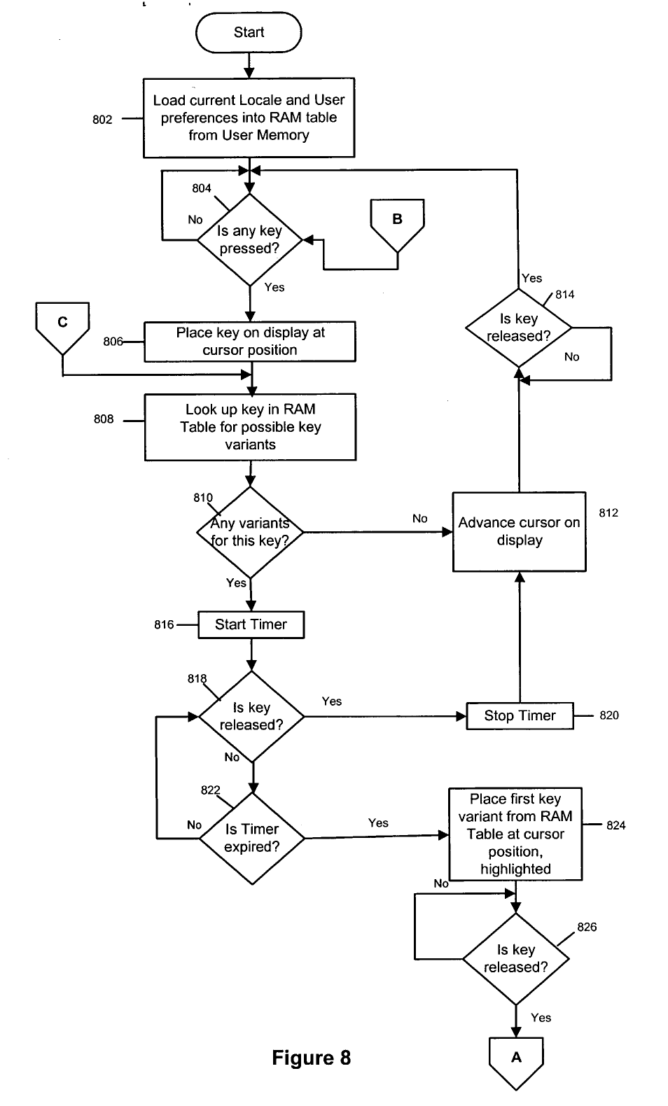

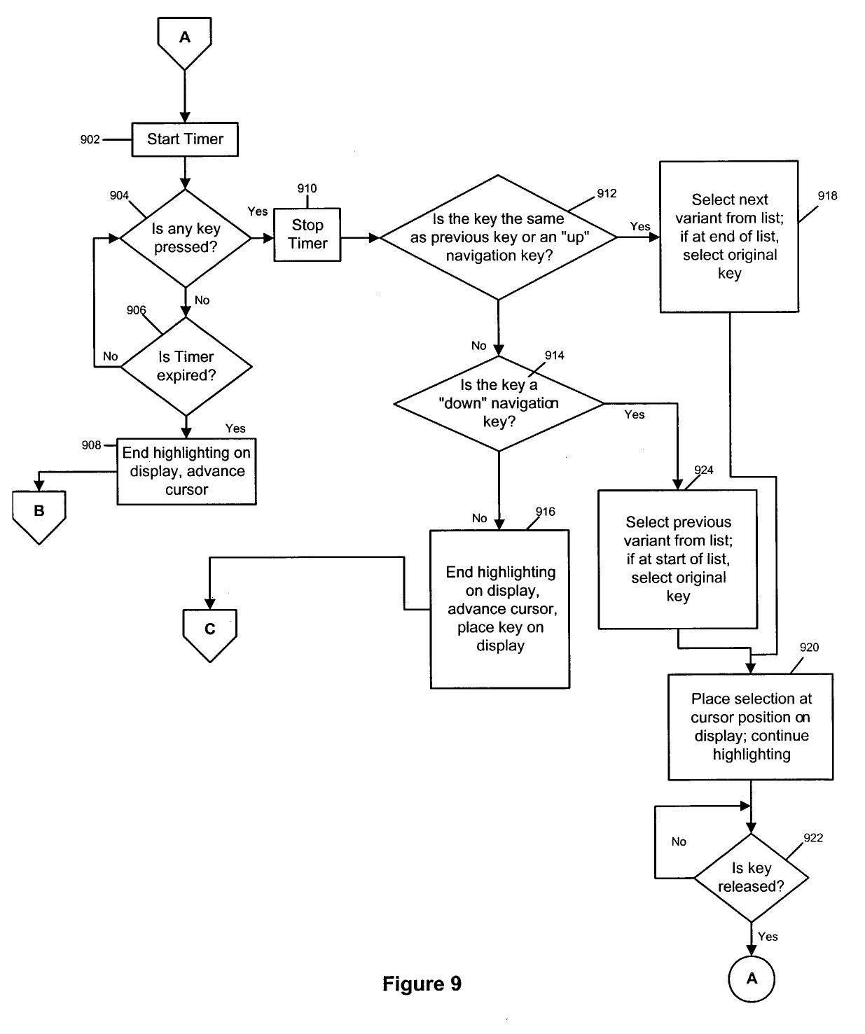

The operation of a keyboard entry method according to one embodiment of the invention will now be described with reference to FIGS. 8-9. In step 802, the device 100 loads the current locale and user preferences, including the variant list for the selected language, into the RAM memory 116 from the user memory 108. The current locale is represented as a numeric value assigned to each language choice in FIG. 4. That numeric value controls which table of variants is chosen (each initially made for that language, but user customizable. The system then waits for a key to be pressed in step 804. Once a key is pressed, the device 100 places the character of the key pressed on display at the cursor position in step 806. The system (i.e., the CPU 118) then looks to see if the key has any variants listed in the variant list stored in the RAM 116 in step 808. If it is determined in step 810 that no variants exist for this key, the device 100 advances the cursor on the display 106 in step 812. Once it is determined that the key has been released in step 814, the system returns to step 804.

If it is determined in step 810 that variants for the key exist, a timer is started in step 816 to measure a predetermined period of time. The predetermined period of time can be factory set and then customized by the user. The device 100 then determines if the key is released in step 818. If the key is released prior to the expiration of the predetermined period of time, the timer is stopped in step 820 and the system advances the cursor on the display 106 in step 812. If it is determined that the key was not released prior to the expiration of the predetermined time in step 822, the device 100 selects the first variant from the variant list for the key and displays the variant at the cursor position, wherein the variant is highlighted in some manner in step 824. For example, the display can give some visual feedback to the user that the keyboard has entered a special entry mode. Possible ways for highlighting the variants include, but are not limited to, displaying the character position in inverse video, surrounding the character with a graphic window with arrow points, blinking the character on and off, and alternating between the character and an up/down arrow graphic. It will be understood that capitalized versions of character variants are displayed if the user presses the “shift” key prior to holding down the character key. In addition, any non-alphabetic symbols in the variant list would also still appear. The system then waits for the key to be released in step 826. Once the key is released, a timer is started for a predetermined period of time in step 902. The system then determines if a key is pressed before the expiration of the predetermined period of time in steps 904 and 906. Once the predetermined period of time has expired, the highlighting of the displayed character is ended and the cursor on the display 106 is advanced in step 908. In other words, the highlighting will end after a period of inactivity so as to alleviate new user concern or confusion. The system then returns to step 804.

However, if it is determined in step 904 that a key has been pressed before the end of the predetermined period of time, the timer is stopped in step 910. The device 100 then determines if the key is an “up” navigation key or a “down” navigation key in steps 912 and 914, respectively, or if the same key is being pressed in the embodiment where no navigation is used to facilitate scrolling through a character list. For example, the same key may be used to cycle forwards through the character list. In this embodiment, no arrow key is necessary.

Where a navigation key is used, instead of a character key, if the key is neither and “up” nor “down” navigation key, the highlighting on the display 106 is stopped, the cursor position on the display 106 is advanced and the character associated with the newly pressed key is displayed, if applicable, in step 916. In other words, when highlighting is active, pressing any keys besides the up/down arrow keys (or some other designated navigation keys for moving through the variant list) performs the two actions of entering the currently displayed letter, and whatever action is associated with the new key. The new key may be associated with the next letter in the current word, a navigation key such as “tab” or any other function key. The system then returns to step 808.

If it is determined that the newly pressed key is an “up” navigation key, the next variant character on the variant list is selected in step 918. It will be understood that the original character for the key can also be included in the variant list. In addition, if all of the variants in the variant list have been displayed, the original character can be selected. The selected variant (or original character) is placed at the cursor position on the display and the highlighting is continued in step 920. The system then waits for the key to be released in step 922 and returns to step 902 when the key is released.

If it is determined that the key is a “down” navigation key in step 914, the previous variant on the variant list is selected in step 924. It will be understood that the original character for the key can also be included in the variant list. In addition, if all of the variants in the variant list have been displayed, the original character can be selected. Accordingly, the processing circuitry, through a user interface (GUI in this example), receives a selected variant. The selected variant (or original character) is placed at the cursor position on the display and the highlighting is continued in step 920. The system then waits for the key to be released in step 922 and returns to step 902 when the key is released.

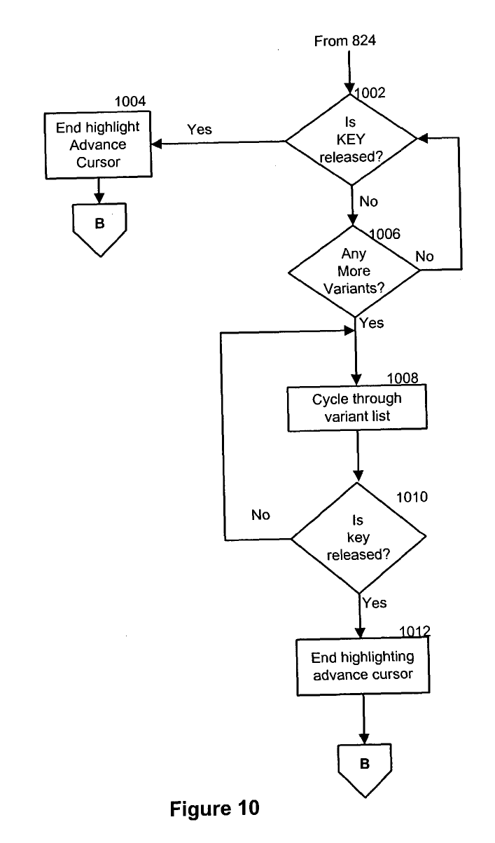

According to another embodiment of the invention, the list of variants for a selected key can be displayed and cycled through by simply continuing to hold down the key which has been pressed as illustrated in FIG. 10. The process illustrated in FIG. 9 begin after step 824 of FIG. 8. For the sake of brevity, a description of steps 802-824 will not be repeated here. In step 1002, it is determined whether the key has been released. If the key has been released, the highlighting is ended and the cursor position is advanced on the display 106 in step 1004. The system then returns to step 804.

If the key has not been released, the system checks to see if there are any more variants in the variant list for the pressed key in step 1006. It will be understood by one skilled in the art that the variant list may contain the original character as well as the variants. If it is determined that there are no other variants in the variant list the system returns to step 1002. However, if it is determined that there are more variants (and/or the original character) in the variant list, the device 100 begins cycling through all of the variants in the variant list in step 1008 by placing each variant in the highlighted cursor position for a predetermined period of time, which may be a different period of time from other predetermined periods of time if desired, until the key is released. Once it is determined that the key has been released in step 1010, the highlighting is stopped and the cursor position on the display is advanced in step 1012. The system then returns to step 804.

In another embodiment, and a preferred embodiment where dedicated navigation keys (e.g., no arrow keys) are not provided, pressing the same key multiple times allows a user to cycle through the list and eliminate the need for a cycling list.

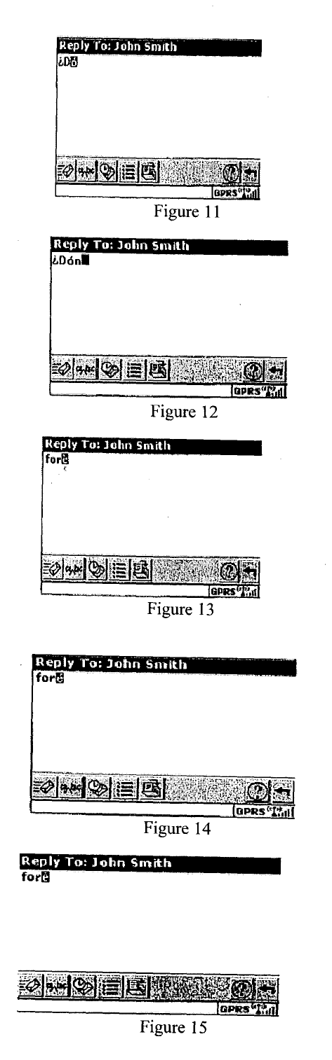

Several illustrative examples of what a user might see on the display screen using embodiments of the invention will now be described. In the first example illustrated in FIGS. 11-12, the user has selected the Spanish language variant list and wants to type the word “Dónde” on the display. After pressing the “shift” key together with the “d” key, the user presses and holds down the “o” key for longer than the previously described predetermined period of time. After the “o” key has been held down for the predetermined period of time, the cursor position becomes highlighted and the first variant from the variant list is displayed. In this example, the first variant for the “o” key is “ó” which is displayed in FIG. 11 in a reverse video manner. While there are many variants of the letter “o” in other languages, such as “ò”, “ö”, “ô”, and “œ”, the variant “ó” is the only variant used in the Spanish language so it would be the optimal choice to be displayed first. The user then presses the “n” key to continue the word “Dónde”, the device 100 interprets this action as an indication that the user intends to select “ó” and is continuing with their touch typing. As a result, the highlighting comes to end, the cursor position is advanced and the character “n” appears at the advanced cursor position as illustrated in FIG. 12. Thus, no special keystroke is needed to end the variant selection mode of the keyboard.

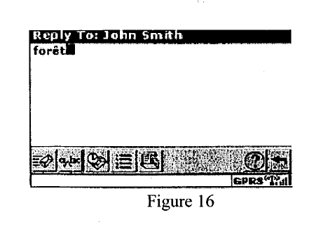

In a second illustrative example illustrated in FIGS. 13-16, the user has selected the French language variant list and wants to type the word “forêt” on the display. After pressing the “f”, “o” and “r” keys, the user presses and holds down the “e” key for longer than the previously described predetermined period of time. After the “e” key has been held down for the predetermined period of time, the cursor position becomes highlighted and the first variant form the variant list is displayed. In this example, the first variant for the “e” key is “è” which is displayed in FIG. 13 in a reverse video manner. However, this variant of the letter “e” is not the desired variant. According to one embodiment of the invention, the user then presses either the up or down arrow keys in order to cycle through the variants of the letter in the variant list. In another embodiment of the invention, the user simply holds down the “e” key to cycle through the variants of the letter in the variant list. In this example, the next variant to be displayed is “é” as illustrated in FIG. 14. Since this variant is incorrect, the user continues to cycle through the variant list. The next variant to be displayed is “ê” as illustrated in FIG. 15. Having found the correct variant, the user then presses the letter “t” to complete the word “forêt”. As illustrated in FIG. 16, the highlighting comes to end, the cursor position is advanced and the character “t” appears at the advanced cursor position.

The invention provides, among other advantages, a method and apparatus for easily and logically selecting character variants with few keystrokes from stored variant lists.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

What is claimed is:

1. A method for entry of variant characters using a keyboard of a device, comprising:
detecting when a character key on the keyboard is depressed for a predetermined period of time and entering a variant character selection mode;
highlighting a character associated with the character key at a cursor position on a display of the device;
cycling through stored variant characters associated with the character key at the cursor position when a navigation key is repeatedly pressed;
ending highlighting when any key other than the navigation key is pressed; and
displaying a variant character that was highlighted when the highlighting ended to designate an entered character for the cursor position.

2. The method according to claim 1, wherein the navigation key is at least one of an up arrow key and a down arrow key, wherein the up arrow key cycles through the stored variant characters in a forward manner, and wherein the down arrow key cycles through the stored variant characters in a reverse manner.

3. The method according to claim 1, wherein a list of the stored variant characters is custom selectable through a user interface of the device.

4. The method according to claim 1, further comprising:
receiving a language selection; and
determining the stored variant characters based on the language selection.

5. The method according to claim 4, wherein a list of the stored variant characters is customizable.

6. The method according to claim 1, wherein the stored variant characters include a base character.

7. The method according to claim 1, further comprising
detecting an activation of a second character key that does not have stored variant characters associated therewith and;
displaying a character associated with the second character key.

8. The method according to claim 1, further comprising ending highlighting after a predetermined period of time of inactivity.

9. A method for entry of variant characters using a keyboard of a device, comprising:
detecting when a character key on the keyboard is depressed for a predetermined period of time and entering a variant character selection mode;
highlighting a character associated with the character key at a cursor position on a display of the device;
cycling through stored variant characters associated with the character key at the cursor position while the character key is depressed;
ending highlighting when the character key is released; and
displaying a variant character that was highlighted when the character key was released to designate an entered character for the cursor position.

10. The method according to claim 9, wherein a list of the stored variant characters is custom selectable through a user interface.

11. The method according to claim 10, further comprising receiving data representing a selected language that determines the list of stored variant characters to be used by the device.

12. The method according to claim 11, wherein the list of stored variant characters is customizable through a user interface of the device.

13. The method according to claim 9, further comprising:
detecting activation of a second character key that does not have stored variant characters associated therewith; and
displaying a character associated with the second character key.

14. An electronic device comprising:
a display;
a user input interface having a plurality of character keys and at least one navigation key; and
processing circuitry operatively coupled to the user interface and the display, the processing circuitry being operative to:
detect when a character key is depressed for a predetermined period of time and enter a variant character selection mode;
highlight a character associated with the character key at a cursor position on the display;
cycle through stored variant characters associated with the character key at the cursor position when the at least one navigation key is repeatedly pressed;
end highlighting when any key other than the at least one navigation key is pressed; and
display a variant character that was highlighted when the highlighting ended to designate an entered character for the cursor position.

15. The electronic device according to claim 14, wherein the at least one navigation key is at least one of an up arrow key and a down arrow key, wherein the up arrow key cycles through the stored variant characters in a forward manner, and wherein the down arrow key cycles through the stored variant characters in a reverse manner.

16. The electronic device according to claim 14, wherein the user interface further receives a user selected language, and wherein the processing circuitry determines a list of stored variant characters to be used based on the user selected language.

17. The electronic device according to claim 14, wherein the user interface allows a user to customize the predetermined period of time.

18. The electronic device according to claim 14, wherein the processing circuitry is further operative to end highlighting after a predetermined period of time of inactivity.

19. An electronic device comprising:
a display;
a user interface having a plurality of character keys; and
processing circuitry operatively coupled to the user interface and the display, the processing circuitry being operative to:
detect when a character key is depressed for a predetermined period of time and enter a variant character selection mode;
highlight a character associated with the character key at a cursor position on the display;
cycle through stored variant characters associated with the character key at the cursor position on the display while the character key is depressed;
end highlighting when the character key is released; and
display a variant character that was highlighted when the character key was released to designate an entered character for the cursor position.

20. The electronic device according to claim 19, wherein the processing circuitry further operates to:
detect activation of a second character key that does not have stored variant characters associated therewith; and
display a character associated with the second character key on the display.
